(19) United States
(12) Patent Application Publication
(10) Pub. No.: US 2026/0143523 A1
(43) Pub. Date: May 21, 2026

(54) DYNAMIC COORDINATED CHANNEL ALLOCATION SYSTEM FOR CLUSTERS OF WIRELESS NETWORKS

(71) Applicant: AIRTIES S.A.S., Paris (FR)

(72) Inventors: Mehmet Sukru KURAN, Istanbul (TR); Melih KILIC, Istanbul (TR); Oguz Kaan KOKSAL, Istanbul (TR)

(73) Assignee: AIRTIES SAS, Paris (FR)

(21) Appl. No.: 19/119,324

(22) PCT Filed: Oct. 11, 2023
(86) PCT No.: PCT/IB2023/060245

§ 371 Date: Apr. 8, 2025

Related U.S. Application Data
(60) Provisional application No. 63/415,157, filed on Oct. 11, 2022.

(51) Int. Cl. H04W 74/0808

(52) U.S. Cl. CPC H04W 74/0808

(57) ABSTRACT

A method and apparatus may collect information related to dynamically allocating an optimal channel for a plurality of wireless networks. The plurality of wireless networks may be grouped together based on one or more criteria. A channel allocation may be determined based on one or more factors, including an assessment of an optimization algorithm.

### CROSS-REFERENCE TO RELATED APPLICATIONS

This application claims the benefit of U.S. Provisional Application No. 63/415,157, filed Oct. 11, 2022, the contents of which are incorporated herein by reference.

### BACKGROUND

In the realm of wireless networks, efficient channel allocation is a significant concern. Wireless networks often share the same medium with other networks operating in the same vicinity. This can lead to a reduction in wireless capacity when two separate networks operate on the same frequency channel. The capacity of these networks can be improved if they operate on non-overlapping channels.

### SUMMARY

A method and apparatus may collect information related to dynamically allocating an optimal channel for a plurality of wireless networks. The plurality of wireless networks may be grouped together based on one or more criteria. A channel allocation may be determined based on one or more factors, including an assessment of an optimization algorithm.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates an example communications network;

FIG. 2 illustrates an example station;

FIG. 3 illustrates an example of multiple wireless networks;

FIG. 4 illustrates an example of overall time schedule for channel CCA measurements, measurement cycle, and decision period;

FIG. 5 illustrates an example of a connectivity graph composed of three clusters;

FIG. 6 illustrates an example of an depth first search algorithm for connected APs;

FIG. 7 illustrates an example of an depth first search algorithm for connected WMNs;

FIG. 8 illustrates an example process; and

FIG. 9 illustrates an example process according to or more techniques disclosed herein.

### DETAILED DESCRIPTION

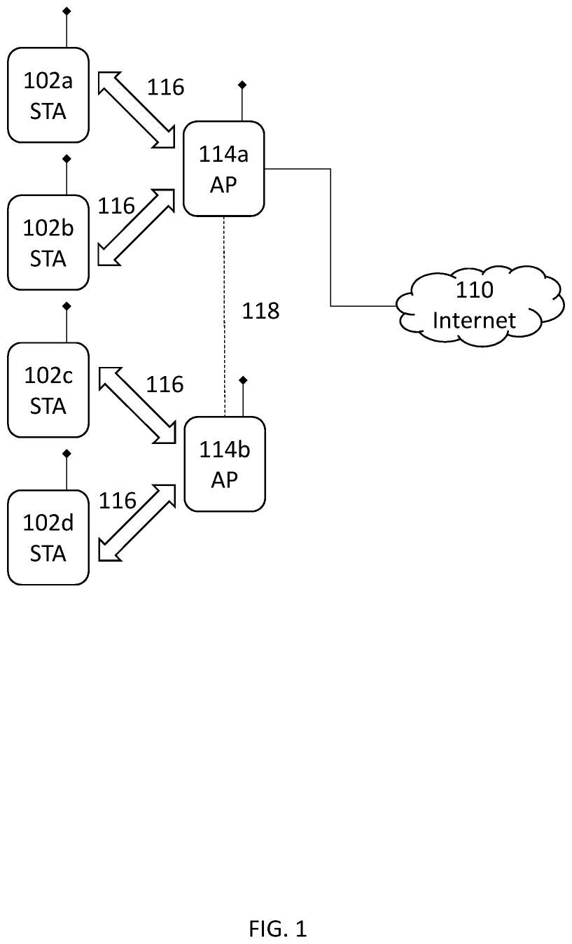

FIG. 1 is a diagram illustrating an example communications system 100 in which one or more disclosed examples, techniques, features, etc., may be implemented. The communications system 100 may provide communication access for content, such as voice, data, video, messaging, broadcast, etc., to multiple wireless or wired device users. The communication system 100 may enable multiple wireless users to access such content through the sharing of system resources, including wireless bandwidth. The communication system may comprise one or more user devices, such as stations (STA) (e.g., 102a, 102b, 102c, 102d, collectively or individually referred to as 102, and one or more access points (APs) (e.g., 114a and 114b). Any given STA 102 may communicate with an AP 114 over an air interface 116 (e.g., wireless medium, wirelessly, etc.). The APs 114a and 114b may communicate with each other via 118 using a wired or wireless connection. In one example, the 118 connection is wireless and it is used to create a mesh network of APs. For example, even though only two APs are shown in FIG. 1, the mesh network may comprise of more than two APs, where each AP is connected to at least one other AP wirelessly, and these connections terminate in a primary AP. Any wireless network, such as the mesh network, may be locally controlled (e.g., via a primary AP) or cloud-controlled via a server (e.g., sending instructions to a primary AP that then disseminates the configuration/instructions, and/or sending configuration/instructions to all APs), not shown.

The AP 114a or 114b (collectively or individually referred to as 114) in FIG. 1 may be a wireless router, an access point, a gateway, a customer premise equipment, and/or a combination of one or more of the aforementioned devices (e.g., either physically or virtually). The AP 114 may implement a radio technology such as IEEE 802.11 to establish a wireless local area network (WLAN). The AP may have a direct connection to the Internet 110.

The APs may create a wireless local area network (WLAN). A WLAN in Infrastructure Basic Service Set (BSS) mode may have an Access Point (AP) for the BSS and one or more stations (STAs) associated with an AP. The AP may have access or an interface to a Distribution System (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through one or more AP, for example, where the source STA may send traffic to the AP and the AP may deliver the traffic to another AP and/or the destination STA.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In some cases, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum.

WLAN systems, which may support multiple channels, and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

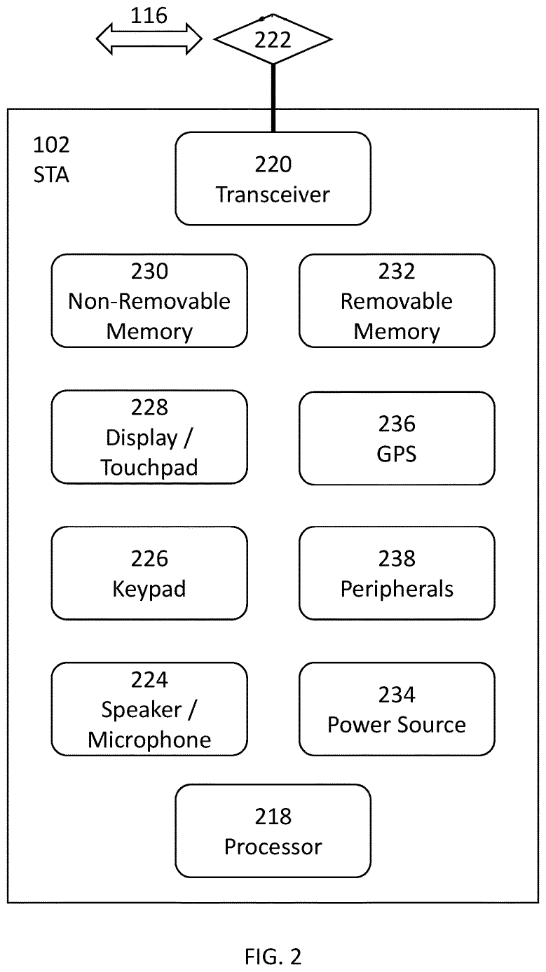

FIG. 2 is a diagram illustrating an example of a device, such as a station (STA) (e.g., 102a, 102b, 102c, 102d). As shown, the STA 102 may include a processor 218, a transceiver 220, a transmit/receive element 222, a speaker/microphone 224, a keypad 226, a display/touchpad 228, non-removable memory 230, removable memory 232, a power source 234, a global positioning system (GPS) chipset 236, and/or other peripherals 238, among others. It will be appreciated that the STA 102 may include any sub-combination of the elements described herein while remaining consistent with an example described herein. Further, it will be appreciated that any of the one or more components/elements described with relation to FIG. 2 may by operatively connected to each other, indirectly, or directly, in order to achieve a desired function (e.g., processor 228 may communicate with memory 232 to execute instructions, which then cause a signal to be sent or received by the transceiver 220).

The processor 218 may be a general-purpose processor, a special-purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 218 may perform signal coding, data processing, power control, input/output processing, and/or any other functionality that enables the STA 102 to operate in a wireless environment. The processor 218 may be coupled to the transceiver 220, which may be coupled to the transmit/receive element 222. While FIG. 2 depicts the processor 218 and the transceiver 220 as separate components, it will be appreciated that the processor 218 and the transceiver 220 may be integrated together in an electronic package or chip.

The transmit/receive (e.g., transceiver) antenna 222 may be configured to transmit signals to, or receive signals from, an AP over an air interface 116. For example, the transceiver 220 in conjunction with the antenna 222 may be configured to transmit and/or receive RF signals.

Although the antenna 222 is depicted in FIG. 2 as a single element, the STA 102 may include any number of antennas 222. More specifically, the STA 102 may employ MIMO technology. Thus, in one example, the STA 102 may include two or more antennas 222 (e.g., multiple antennas) for transmitting and receiving wireless signals over the air interface 116.

The transceiver 220 may be configured to modulate the signals that are to be transmitted by the antenna 222 and to demodulate the signals that are received by the antenna 222. The STA 102 may have multi-mode capabilities.

The processor 218 of the STA 102 may be coupled to, and may receive user input data from, the speaker/microphone 224, the keypad 226, and/or the display/touchpad 228 (e.g., a liquid crystal display (LCD) display unit or organic light-emitting diode (OLED) display unit). The processor 218 may also output user data to the speaker/microphone 224, the keypad 226, and/or the display/touchpad 228. In addition, the processor 218 may access information from, and store data in, any type of suitable memory, such as the non-removable memory 230 and/or the removable memory 232. The non-removable memory 230 may include random-access memory (RAM), read-only memory (ROM), a hard disk, or any other type of memory storage device. The removable memory 232 may include a subscriber identity module (SIM) card, a memory stick, a secure digital (SD) memory card, and the like. In other instances, the processor 218 may access information from, and store data in, memory that is not physically located on the STA 102, such as on a server or a home computer (not shown).

The processor 218 may receive power from the power source 234, and may be configured to distribute and/or control the power to the other components in the STA 102. The power source 234 may be any suitable device for powering the STA 102. For example, the power source 234 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 218 may also be coupled to the GPS chipset 236, which may be configured to provide location information (e.g., longitude and latitude) regarding the current location of the STA 102. In addition to, or in lieu of, the information from the GPS chipset 236, the STA 102 may receive location information over the air interface 116 from an AP (e.g., APs 114a, 114b) and/or determine its location based on the timing of the signals being received from two or more nearby base stations. It will be appreciated that the STA 102 may acquire location information by way of any suitable location-determination method while remaining consistent with a given example.

The processor 218 may further be coupled to other peripherals 238, which may include one or more software and/or hardware modules that provide additional features, functionality and/or wired or wireless connectivity. For example, the peripherals 238 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 238 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The STA 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 218). In an example, the STA 102 may include a half-duplex radio for which transmission and reception of some or all of the signals (e.g., associated with particular subframes for either the UL (e.g., for transmission) or the DL (e.g., for reception)).

Although not shown, all descriptions related to the functionality and hardware of the STA 102 may be applicable to an AP 114. Additionally, an AP 114 (e.g., router, gateway, controller, etc.). may include additional communication interfaces, processing power, and the like in order to carry out one or more the methods, processes, functions, mechanisms, examples, techniques, approaches, etc., described herein.

Although not shown, all descriptions related to the functionality and hardware of the STA 102 may be applicable to the server. Additionally, a server may include additional communication interfaces, processing power, and the like in order to carry out one or more of the methods, processes, functions, mechanisms, examples, techniques, approaches, etc., described herein.

Any of the methods, processes, functions, mechanisms, examples, techniques, approaches, etc., described herein, may be implemented by a cloud controller running on a server, locally on an AP, and/or in combination with a cloud component and a local AP component. Further, any of the methods, processes, functions, mechanisms, examples, techniques, approaches, etc., described herein, may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read-only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

In one scenario, there may be clusters of wireless networks, such as multiple wireless networks as described with regard to FIG. 1.

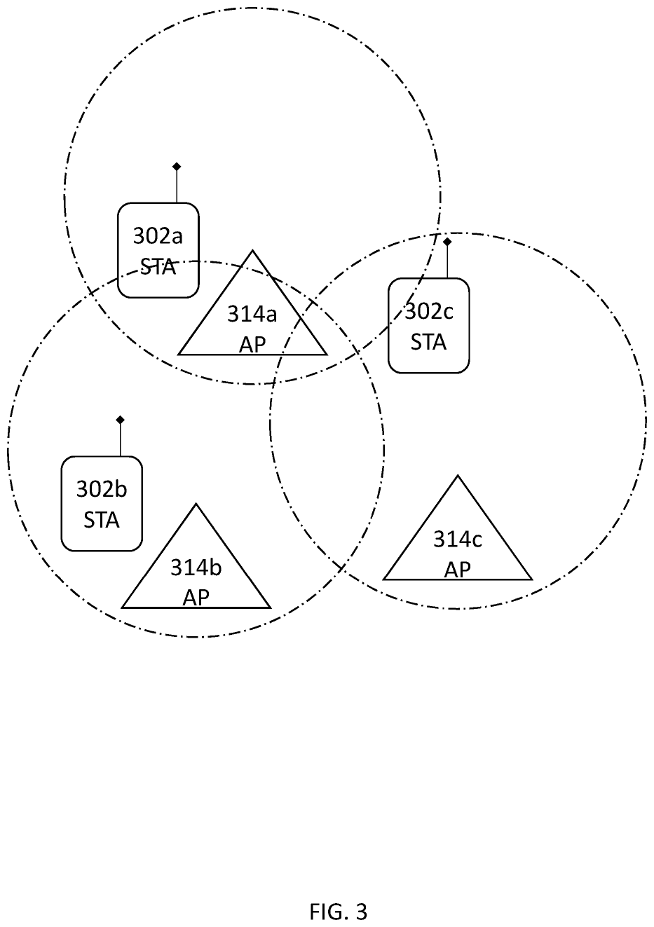

FIG. 3 illustrates an example of a cluster of wireless networks. There may be multiple wireless networks, where each network may have one or more APs, and one or more STAs may connect to an AP. As shown, some of the wireless networks overlap, where each AP (314a, 314b, 314c) is its own wireless network, each with a STA (302a, 302b, 302c, respectively).

In such a case, channel allocation in wireless networks may be critical because the wireless medium may be shared with other wireless networks that operate in the vicinity. When two separate networks in close vicinity of each other operate in the same frequency channel, they share the wireless medium resulting in reduced wireless capacity for each. Separate wireless networks can improve their capacity (e.g., throughput capacity) when they operate in non-overlapping channels with each other. A wireless network may comprise of a single Gateway (GW), or a single Access Point (AP) or a combination of a single GW and one or more APs or a combination of two or more APs. A wireless network may be a mesh network, where APs in the network form wireless and/or wired connections, so-called backhaul links, between each other.

A dynamic channel allocation approach is needed for use in wireless networks in use cases where one or more wireless networks may exist, such as a multiple wireless networks deployment in Multi-Dwelling Units (MDUs). The dynamic channel allocation may coordinate channel allocation among wireless networks residing in each unit. A dwelling unit may be a home, or an office. The subject matter described herein is an extension (for MDU deployments) of the Cloud Assisted Channel Selection (CACS) method, which is disclosed in Patent Application No. U.S. Ser. No. 15/876,916 and hereby incorporated by reference in its entirety.

Dynamic channel allocation may be implemented by one entity, or by multiple entities. A dynamic channel allocation process may run in a cloud server, and the channel selection for each wireless network (e.g., residing in different dwell units) may be performed in the cloud, and the selected channel allocation may be delivered by the cloud to each wireless network (e.g., residing in different dwell units) to optimize the capacity of each wireless network. Such a process may perform a channel availability forecast for each channel and for each wireless network by considering whether the networks in separate units are neighbors or not, and may use an optimization algorithm to find the channel allocation that maximizes the total channel availability of all APs at their allocated channels. Such a channel allocation process may also take into account whether the allocated channels are being used for backhaul links of wireless networks.

Measurement for the availability of a Wi-Fi channel may be a parameter for any channel allocation scheme designed for Wi-Fi networks. Moreover, the availability of Wi-Fi channels may be time-varying due to uncontrolled sources causing interference in a time-varying fashion. Therefore, a dynamic channel allocation (DCA) approach may be necessary when one or more Wi-Fi networks exist within range of each other.

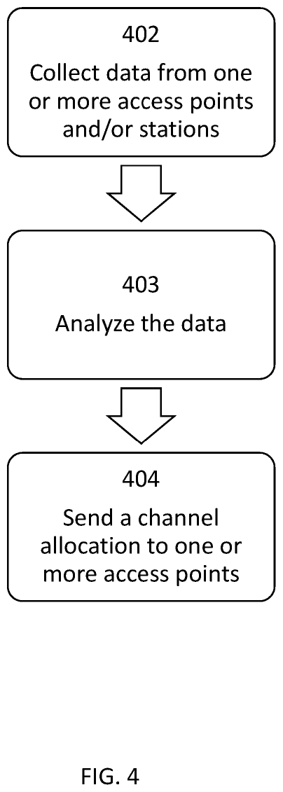

FIG. 4 illustrates an example of a channel allocation scheme. Generally, any channel allocation scheme may perform three functions (e.g., implemented by a controller in the cloud and/or in an AP): 402) collecting data, which may include various measurements (e.g., as disclosed herein) that relate to the performance and operation of a given network; 404) analyze, organize, and process the data that has been collected; and/or 406) send a channel allocation to one or more access appoints based on the analysis that determines some improvement to the network can be made, or will be achieved in the future, if a channel allocation is made.

In the case of a single-AP channel allocation process, there may be one or more functions, such as: measurement collection and aggregation, forecasting, and/or channel ranking.

CSMA/CA (e.g., of IEEE 802.11) may use a channel availability metric called the clear channel assessment (CCA) value to determine an availability of the current operating channel at a given time. In order to have a complete look at the channel spectrum, a channel allocation scheme may require the availability of information of all potential channels. The measurement collection function may conduct CCA measurements on all potential channels in each frequency band and use this set of CCA measurements as the key availability value of all frequency bands.

A Wi-Fi device, AP or STA, may actively conduct CCA measurement in its operating channel all the time, at specific times, or on an as needed basis. When an AP is to conduct a CCA measurement in an off-channel (e.g., a channel other than its operating channel), the device may temporarily switch to this off-channel, operate in that channel for a short while, and return to its operating channel. This switch is inherently disruptive to the routine operation of the AP and the time spent in the off-channel (e.g., the measurement duration) may be kept short to minimize this disruption. On the other hand, a longer measurement duration may have higher accuracy regarding the availability of the target off-channel. In one example, based on trials in various test environments, a measurement duration between 30 and 50 ms may balance these competing goals, where the measurement quality may be relatively high without causing disruptions to time-critical applications.

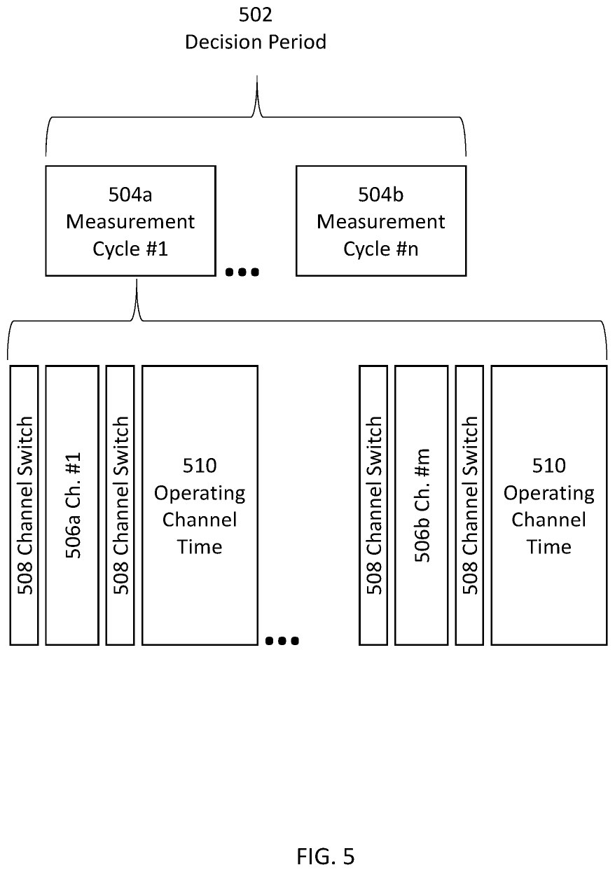

FIG. 5 illustrates an example of the overall time schedule for channel CCA measurements, measurement cycle, and decision period. As shown, there is a measurement cycle (e.g., 504a, 504b, etc.) composed of measurements (e.g., 506a, 506b, etc.), channel switch times (e.g., 508), as well as an operating channel time (e.g., 510) where the AP operates on its operating channel normally. This cycle may be repeated (e.g., cycle #n) periodically to gather more data regarding each channel and draw a more accurate picture of each channel. Then, the measurement data of each measurement cycle within a period called the decision period may be aggregated into a single value via an averaging procedure, as described further herein. The aggregation step may smooth out fluctuations in measurements in order to generate representative data regarding a time period for a given channel.

Based on collecting the representative data regarding each channel in each frequency band, a proactive DFS approach may be used, and then a forecast of the channel availability of all channels in the next decision period may be made and utilized in a channel allocation procedure.

For the forecasting, an algorithm may be used, where i and j denote the indices for the APs and the channels, respectively. One or more forecasting methods may be utilized by a controller to forecast the channel availability in the next decision period,

$${Y}_{ik}^{t + 1} ,$$

using the past observed data vector, \vec{X}ᵢⱼ.

For example, an exponential smoothing technique may be used:

$${Y}_{ik}^{t + 1} = α \cdot {X}_{ij}^{t} + ( 1 - α ) \cdot {Y}_{ij}^{t} \qquad Eq . 1$$

where α∈[0.2:0.2:1]

For example, a moving average technique may be used:

$${Y}_{ij}^{t + 1} = \frac{{Σ}_{k = t - β - 1}^{t} {X}_{ij}^{t}}{β} \qquad Eq . 2$$

where β∈[2:2:16]

For example, a bi-directional exponential smoothing technique may be used, where the exponential smoothing both in forward and backward directions (e.g., backcasting), and then the average of the two results may be taken.

Table 1 lists the nomenclature for single AP channel allocation, as referenced herein.

TABLE 1
Nomenclature for Single AP Channel Allocation

| | |
|---|---|
| φ | Set of predictors |
| φₖ | k^{th} predictor in φ |
| ${X}_{ij}^{t}$ | Availability of j^{th} channel for the i^{th} AP in the t^{th} decision period |
| ${Y}_{ij}^{t}$ | Availability forecast of i^{th} channel for the i^{th} AP in the t^{th} decision period |
| ${\hat{Y}}_{ij}^{t} ( {φ}_{k} )$ | Availability forecast of i^{th} channel for the i^{th} AP in the next decision period of predictor φₖ |
| Ŷᵢⱼ | Predicted availability of j^{th} channel for the i^{th} AP in the next decision |
| MSE(φₖ) | Mean square error (MSE) of predictor φₖ |
| θ | Time horizon for evaluating MSE of predictors (in terms of decision periods) |
| α | Weight parameter of exponential smoothing methods |
| β | Window size parameter of moving average method |
| τ_{chsw} | Channel switch threshold for single AP channel allocation mechanism |

These forecasting techniques may result in a high degree of accuracy when utilized with actual Wi-Fi interference data. Each technique may be used with a parameter combination (e.g., α for exponential and bi-directional exponential smoothing; β for moving average) as a predictor (e.g., a predictor may be a combination of a technique and a certain parameter value). The forecast value may be evaluated for the next decision period combined with its mean square error (MSE) as a pair, (Yᵢⱼ, MSE) for each predictor. Here, MSE values may be evaluated using the errors over the last θ decision period values. Then, the forecast having the minimum MSE value may be selected as the Ŷᵢⱼ to be used as the predicted channel availability for the i^{th} AP of the j^{th} channel.

Let φ be the set of predictors, and φₖ represent a particular predictor within φ. Ŷᵢⱼ may be evaluated as

$${\hat{Y}}_{ij} = {Y}_{ij} ( {φ}_{k} ) : MSE ( {φ}_{k} ) = min ( MSE ( {φ}_{l} ) , k ∈ ϕ , ∀ l ∈ ϕ ) \qquad Eq . 3$$

The channel forecast values may be used to determine if a particular interface of an AP needs to switch to another channel or not. This assessment may require a comparison and/or ranking of the channels in question (e.g., channels for which have been measured, assessed, and/or predicted, as described herein). Once this is determined, the controller may send a message (e.g., configuration or instructions) to the AP in question to switch channels.

Generally, depending on whether a WMN is utilized, and depending on whether one or more frequency bands are being evaluated, the best channel must be determined (e.g., of the channels that have been forecasted, the channel that has been ranked the highest in providing the optimal performance, with regard to, for example, interference). This channel may then be used in an allocation process. For example, a cloud network controller may receive information (e.g., measurements from the access points) and store the obtained measurements. The cloud network controller may analyze/the information and/or use the information for forecasting, and ultimately determine one or more optimal/best channels for a given one or more access points. The one or more optimal/best channels may be sent to access points in the wireless mesh network as instructions to switch to the indicated channel and/or suggestion to switch based on one or more conditions. In one implementation, the cloud network controller sends only the best channel information to the wireless mesh network. In another implementation, the best channel information is a list of channels sorted according to their qualities.

In the 2.4 GHz frequency band interface, the forecast channel availabilities of the best channel and the operating channel are compared against each other. If the best channel has at least a certain threshold, τ_{chsw}, and better channel availability than the operating channel, the process allocates this best channel as the new operating channel of that AP. Otherwise, the improvement is deemed to be too low for the small service disruption due to the channel change and is ignored.

In the 5 GHz frequency band interface, a similar method can be followed.

If the AP is part of a wireless mesh network (WMN) composed of multiple APs where the inter-AP traffic is carried over one or more backhaul frequency bands (e.g., carried over the 5 GHz interface), a WMN-wide channel allocation may be needed since the whole WMN may be using a single channel (e.g., 5 GHZ channel). In such scenarios, after calculating the channel availability forecasts for individual APs, WMN-wide forecasts may be calculated for each channel by taking the worst channel availability value among the APs constituting the WMN. Then, the same threshold may be applied to determine if a channel change is necessary and to which channel similar to the aforementioned process.

For example, if the average availability is taken to determine a channel, and a cloud controller makes a decision to use this channel, then the APs within the WMN with the lower than average availability may suffer. In order to avoid this, the worst of the representative data may be used for forecasting, thereby increasing the likelihood of a new channel allocation being beneficial for all/most APs.

Finally, the 6 GHz frequency band interface may be similar to either the 2.4 GHz scenario or the 5 GHz frequency band scenario depending on the use of the 6 GHz frequency band.

For ease of explanation, a single-AP channel allocation scheme has been described, however, it is noted that these same techniques may be applied to multi-AP or AP-group channel allocation scenarios. In order to move from a single-AP channel allocation scheme to an AP-group channel allocation scheme, initially a group of APs must be determined, by finding connected groups of APs in a given AP population on which independent coordinated channel allocations may be calculated. This process of determining connected groups of APs may comprise of one or more functions, such as neighbor discovery, cluster formation, and/or community formation.

For neighbor discovery, in an AP-group channel allocation scheme, APs able to detect each other's signal should be in the same group since their Wi-Fi transmissions may cause Co-Channel Interference (CCI) or Adjacent Channel Interference (ACI) to each other. In order to maximize transmission speed and minimize bit error rates, Wi-Fi transmissions use a variety of rates (e.g., modulation and coding schemes-MCS); and the lower the rate, the longer the range of the transmission. As part of a passive scanning mechanism for discovering nearby APs, each AP may transmit a beacon frame periodically at the lowest available rate (e.g., MCSO). For the purpose of illustration, one AP that can detect the beacon frames of another AP may be referred to as connected; between APₚ and AP_{q}, if APₚ and AP_{q} are able to detect the Wi-Fi beacon frames of each other in the selected frequency band, then these two APs may be grouped together and a connection between these two illustrates the detectability of the beacon frame, which in turn helps in understanding where interference may arise.

Based on this definition of a group, for neighbor discovery, a beacon frame may need to be monitored for and captured. A beacon frame capturing step may be added to the measurement procedure of the measurement cycle described herein. The beacon frames captured (e.g., from each AP) in the same frequency band with unique BSSI values may be aggregated to form a neighboring AP list for each frequency band. Finally, each such neighboring AP may be considered to have a connection with this AP (e.g., that performed the beacon capture) in that frequency band and a connectivity graph can be built with this connection information.

Let P_{f}(V,ε_{f}) be the connectivity graph of an AP population in the frequency band f where V is the set of APs in the population and ε_{f} is the set of connections between this set of APs in the frequency band f. Note that an AP in the population may have connections with APs that are not in V (e.g., all the APs for company A in the area are in V; all, non-company A APs in the area are not in V, but in beacon discovery, the non-company A beacons will still be heard). Since control (e.g., channel allocation) traditionally only extends to those APs within a controller's network (e.g., company A), then channel allocation cannot be controlled for such uncontrolled APs (e.g., non-company A), and these connections may be disregarded. There may be different connectivity graphs in each frequency band since the transmission power of APs change between frequency bands, affecting the set of connections. The uncontrolled APs may still be considered in the ultimate determination, but they may not be included in the graph.

Table 2 provides an example of nomenclature for the description of clustering and community detection as described herein.

TABLE 2
Nomenclature of Clustering and Community Detection

| | |
|---|---|
| V | Set of APs in a given population |
| E_{f} | Set of connections of a given AP population in the frequency band f |
| P_{f}(V, E_{f}) | Connectivity graph of an AP population in the frequency band f |
| [symbol] _{f} | Set of AP clusters in P_{f}(V, E_{f}) in the frequency band f |
| V_{c} | Set of APs in AP cluster c |
| E_{c, f} | Set of connections of AP cluster c in the frequency band f |
| G_{cf}(V_{c}, E_{cf}) | Connectivity graph of AP cluster c in the frequency band f |
| [symbol] | Set of WMNs in a given WMN population |
| [symbol] | Set of WMN connections of a given WMN population |
| P( [symbol] , [symbol] ) | Connectivity graph of a WMN population |
| [symbol] | Set of WMN clusters in P( [symbol] , [symbol] ) |
| [symbol] _{c} | Set of WMNs in WMN cluster c |
| [symbol] _{c} | Set of WMN connections of WMN cluster c |
| H_{c}( [symbol] _{c}, [symbol] _{c}) | Connectivity graph of WMN cluster c |
| [symbol] _{cf} | Set of AP communities within AP cluster c in the frequency band f |
| V_{cd} | Set of APs in AP community d of AP cluster c |
| E_{cdf} | Set of connections of AP community d of AP cluster c in the frequency band f |
| M_{cdf}(V_{cd}, E_{cdf}) | Connectivity graph of AP community d of AP cluster c in the frequency band f |
| [symbol] | Set of WMN communities within a WMN cluster c |
| [symbol] _{cd} | Set of WMNs in WMN community d of WMN cluster c |
| [symbol] _{cd} | Set of WMN connections of WMN community d of WMN cluster c |
| N_{cd}( [symbol] _{cd}, [symbol] _{cd}) | Connectivity graph of WMN community d of WMN cluster c |

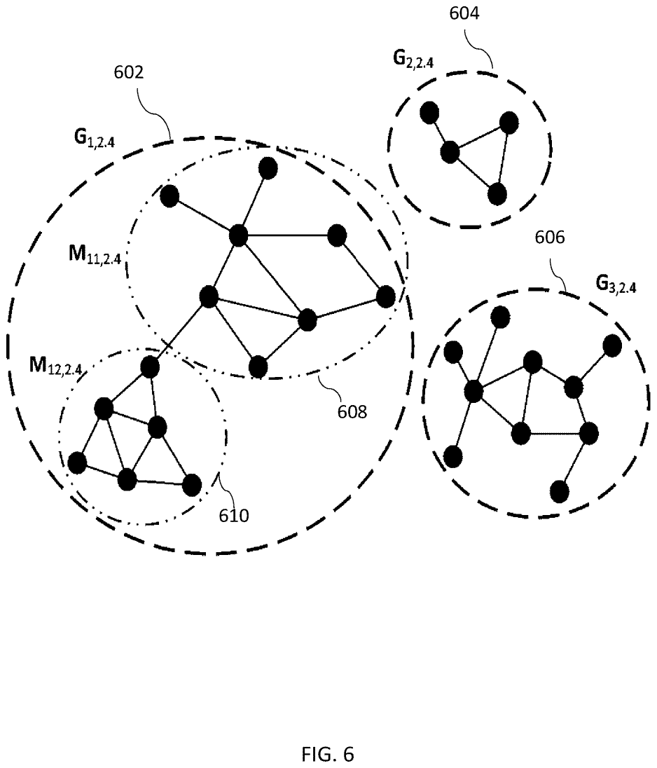

FIG. 6 illustrates an example of a connectivity graph composed of three clusters. Each black dot is representative of an AP. Disjointed connected graphs within P_{f}(V,ε_{f}), may be called clusters, may be found in all applicable frequency bands, as shown. In the 2.4 GHz frequency band, let [symbol] _{2.4} be the set of disjointed connected graphs constituting P_{2.4}(V,ε_{2.4}) and G_{c,2.4}(V_{c},ε_{c,2.4}), represent cluster c in [symbol] _{2.4} (e.g., G_{c,2.4}(V_{c},ε_{c,2.4})∈ [symbol] _{2.4}). Accordingly, in the example 2.4 GHz connectivity graph, P_{2.4}, the three clusters are 602 G_{1,2.4}, 604 G_{2,2.4}, 606 G_{3,2.4}. The first cluster is further decomposed into two communities 608 M_{11,2.4} and 610 M_{12,2.4}.

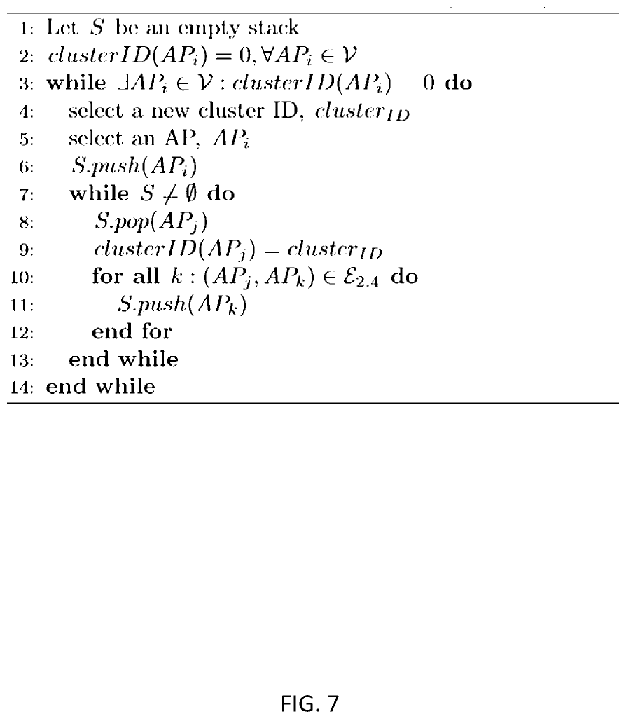

FIG. 7 illustrates an example of a depth first search algorithm for connected APs. The depth first search algorithm may be applied to the example of FIG. 6, where the depth first search algorithm over P_{2.4}(V,ε_{2.4}) to find all G_{c,2.4}(V_{c},ε_{c,2.4})'s.

In the 5 and 6 GHz frequency bands, the same algorithm can be followed using P₅(V,ε₅) and P₆(V,ε₆) respectively.

If the AP is part of a WMN where the inter-AP traffic is carried over a backhaul frequency band (e.g., 5 GHz interface), the algorithm may work with WMNs to find clusters of WMNs instead of working with APs to find clusters of APs. In this context, considering a WMN, if one of its APs has a connection to an AP of another WMN, then these two WMNs have a “WMN connection”. As such, for purposes of illustration, there is a “WMN Connection” between WMNᵢ and WMNᵢ, if at least one AP within WMNᵢ has a connection with at least one AP within WMNᵢ in the backhaul frequency band (e.g., 5 GHz frequency band). For example, a WMN may be a single entity, and a neighbor assessment may be made (e.g., according to one or more techniques herein), and each node of a graph is a WMN, and each connection is a WMN.

Let P( [symbol] ) be the connectivity graph of a WMN population in the backhaul frequency band where [symbol] is the set of WMNs in the population, [symbol] is the set of WMN connections between this set of WMNs, and each AP, AP_{wi}, within a WMN w, w∈ [symbol] , is part of the AP population V (e.g., ∀w∈ [symbol] , ∀AP_{wi}∈w: AP_{wi}∈V). Let [symbol] be the set of disjointed connected graphs constituting P( [symbol] , [symbol] ) and H_{c}( [symbol] _{c}, [symbol] _{c}) represent cluster c in [symbol] (e.g., H_{c}( [symbol] _{c}, [symbol] _{c})∈ [symbol] .

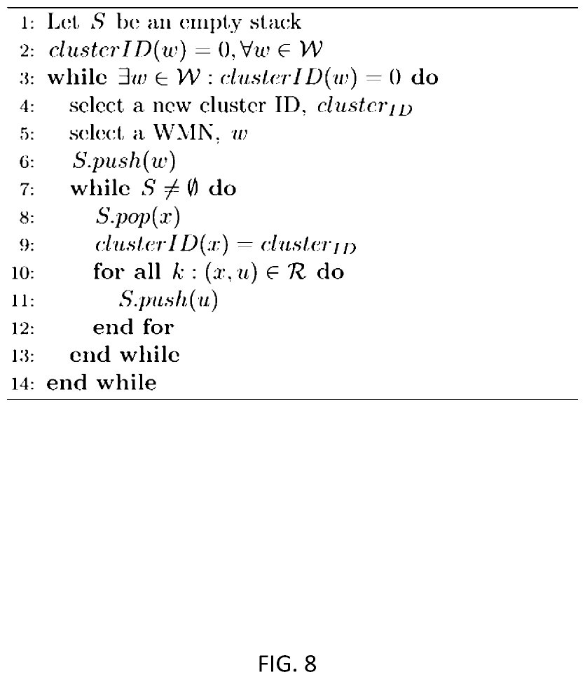

FIG. 8 illustrates an example of a depth first search algorithm for connected WMNs. A modified depth first search algorithm, compared to that shown in FIG. 7, is shown in FIG. 8, and can be used over P( [symbol] , [symbol] ) to find all H_{c}( [symbol] _{c}, [symbol] _{c}).

After the collection of neighbor information regarding an AP population, clusters may be formed/determined, as described herein. The size of the clusters (e.g., if it is too large) may affect the overall performance of a dynamic channel allocation process. For example, a large cluster may be greater than 100 APs. For example, a large cluster may result in the performance of the AP-group channel allocation depending too much on the parameter tuning of the algorithm as well as the initial starting point. Moreover, even heuristic methods may take too long for large clusters, thereby reducing the real-time responsiveness and effectiveness of the resulting channel allocation scheme. Hence, in some cases, depending on the resulting cluster size (e.g., a threshold value), further partitioning an AP cluster (or WMN cluster) into sub-part called “communities” may be needed. A threshold value for the upper limit of a cluster may be determined based on one or more parameters of the dynamic channel allocation process (e.g., some step taking too long, in which case a sub-process can determine to decrease the threshold, and re-run any subsequent determinative step).

Generally, a community may be one or more groups of nodes such that they are internally densely connected but loosely connected with the rest of the graph. This may apply to the examples, scenarios, and techniques described herein. One or more community detection algorithms may be used, such as the minimum-cut, Girvan-Newman, modularity-based algorithms, and/or clique-based algorithms. In one instance, a modularity-based Louvain method may be used that results in high performance while keeping computational complexity low (e.g., [symbol] (n·log(n))). For a given cluster, it is possible that none of the community detection algorithms may result in a partitioning. The algorithms output may indicate that the cluster is too densely connected among itself, and there is only a single community within the cluster.

Performing the Louvain algorithm may start by assigning a different community for each AP within the cluster. Then, for each AP, it may merge it to one of its neighboring communities and check the change in the modularity of the resulting communities. This merging may continue as long as there is improvement (e.g., a threshold). Then, there may be a temporary aggregation of each resulting community into a single node, and the Louvain algorithm runs one more time over this graph of communities to come up with the final community index of each AP.

After community formation/determination, for a non-backhaul band (e.g., the 2.4 GHz frequency band), each cluster, G_{c,f}(V_{c},ε_{c,2.4}), may be further partitioned into set of communities [symbol] _{c,2.4} (i.e., M_{cd,2.4}(V_{cd},ε_{cd,2.4})∈ [symbol] _{c,2.4}); for the backhaul band (e.g., 5 GHz frequency band), each WMN cluster H_{c}( [symbol] ), may be further partitioned into set of WMN communities [symbol] (i.e., N_{cd}( [symbol] )∈ [symbol] ).

Table 3 lists example nomenclature for coordinated channel allocation.

TABLE 3
Nomenclature - Coordinated channel allocation Mechanism

| | |
|---|---|
| \hat{l}_{kf} | Predicted load of k^{th} AP in the frequency band f in the next decision period |
| \hat{Z}ᵢⱼ | Predicted raw availability of j^{th} channel of the i^{th} AP in the next decision period |
| \hat{Q}ᵢⱼ | Predicted load-aware availability of j^{th} channel of the i^{th} AP in the next decision period |
| ${\hat{Q}}_{oj}^{W}$ | Predicted load-aware availability of j^{th} channel of the o^{th} WMN in the next decision period |
| A(G) | Adjacency matrix of G |
| aᵢⱼ | Adjacency of i^{th} and j^{th} APS |
| ccₖₘ | Binary variable denoting if the k^{th} AP is operating at channel m |
| \vec{cc}ₖ | Channel allocation vector for the k^{th} AP |
| \vec{cc} | Channel allocation scheme for a given AP community |
| Iⱼₘ | Interference factor between channels j and m |
| [symbol] _{f} | Set of available channels in the frequency band f |
| ρₒⱼ | Binary variable denoting if the o^{th} WMN is operating at channel j |
| \vec{ρ}ₖ | Channel allocation vector for the o^{th} WMN |
| \vec{ρ} | Channel allocation scheme for a given WMN community |
| temp | Temperature of the Simulated Annealing mechanism |
| rc_{random} | Run count of the SA heuristic with random channel policy |
| rc_{best} | Run count of the SA heuristic with best channel policy |
| rc_{dfs} | Run count of the DFS heuristic |
| ${μ}_{s}^{Q}$ | Avg. predicted load-aware availability of solution s over the selected community |
| ${σ}_{s}^{Q}$ | Std. dev. of predicted load-aware availabilities of solution s over the selected community |
| [symbol] | Set of solutions for a given community |
| [symbol] [symbol] | Set of potential solutions for a given community |
| s̅ | Best solution among |
| | [symbol] for a given community |
| ss | Suggested solution among |
| | [symbol] for a given community |
| τ_{adeg} | Acceptable degradation threshold |
| τ_{mchsw} | Channel switch threshold of the MDU-CACS channel allocation mechanism |
| τ_{chg} | Load-aware availability change threshold |
| γ | Weight parameter used in subjective solution quality calculation |
| [symbol] (i, o) | Function returns 1 if i^{th} AP belongs to the o^{th} WMN, and 0 otherwise |
| [symbol] (i) | Function returns the index of the WMN the i^{th} AP belongs to |

After determining a set of communities, a channel allocation scheme, such as Multi-Dwelling Units Cloud Assisted Channel Selection (MDUs-CACS)), based on the single AP channel allocation scheme described herein, may be performed for each community M_{cd,2.4}(V_{cd},ε_{cd,2.4})∈ [symbol] _{c,2.4} and N_{cd}( [symbol] )∈ [symbol] . The analysis portion of the MDU-CACS mechanism, not including the actual channel allocation process, may comprise one or more functions: measurement collection and aggregation, forecasting, load prediction and pre-processing, finding graph-wide solutions, and/or graph-wide ranking. The first two parts may be performed in the manner as described herein regarding the single AP channel allocation scheme.

For load prediction and pre-processing, in a coordinated channel allocation scheme, in addition to the channel availability and the connectivity information among the APs within P_{f}, the predicted load of each AP in each frequency band, \hat{l}_{kf}, may be helpful to the processing of an ultimate determination. As an example, when an AP is operating at a channel j, it may introduce an interference to all its neighboring APs operating at the same channel by its load. Moreover, the predicted channel availability values, Ŷᵢⱼ, may also already include the loads of adjacent APs and may need to be removed in a pre-processing step.

It follows, then, that a MDU-CACS mechanism may measure the load of each AP in each frequency band in terms of CCA values. Then, the predicted load values of each AP in each frequency band for the next decision period, \hat{l}_{kf}, may be evaluated by a forecasting process, such as that utilized for finding the predicted channel availability values described herein. Next, this predicted load values may be added to the predicted channel availability values of each adjacent AP depending on the interference factor between the channels of the two APs to calculate the raw predicted channel availability values:

$${\hat{Y}}_{ij} = {Y}_{ij} ( {φ}_{k} ) : MSE ( {φ}_{k} ) = min ( M SE ( {φ}_{l} ) ) , k ∈ ϕ , ∀ l ∈ ϕ ) \qquad Eq . 4$$

Where A(P_{f})=[aᵢₖ]_{i,k∈V} is the adjacency matrix of the connected graph P_{f}, ccₖₘ is a binary value denoting if the k^{th} AP is operating at channel m, Iⱼₘ denotes the interference factor between channels j and m, and [symbol] denotes the set of available channels in the selected frequency band.

Here Iⱼₘ∈[0,1] and Iⱼₘ=1, if j=m, representing the CCI effect. The other values represent the ACI effects where 0 means no interference and 1 means full interference between these two channels.

In order to find graph-wide solutions (e.g., channel allocation for an entire population of APs), an optimization problem may be defined and solved for in order to find the channel allocation solution that maximizes the total channel availability of all APs at their allocation channels.

In a non-backhaul band, the decision variables are the binary channel allocation variables, ccₖₘ, which has a value of 1 if the k^{th} AP is operating at channel m, and 0 otherwise. Then, given the raw predicted channel availability values \hat{Z}ᵢⱼ, the adjacency matrix of M (A(M)), and the predicted channel load values at the 2.4 GHZ frequency band \hat{l}_{k,2.4}, the optimization problem can be written as:

$${maximize}_{{cc}_{ij}} {Σ}_{} {Σ}_{j ∈ 2.4} {\hat{Q}}_{ij} {{cc}_{ij}}_{ij}^{t + 1} \qquad Eq . 5$$

Subject to:

$$\begin{matrix}{\hat{Q}}_{ij} = max ( 0 , {\hat{Z}}_{ij} - {Σ}_{{k ∈ {cd ,}_{}}_{k \neq i}} , {Σ}_{m ∈} ( {a}_{ik} {cc}_{km} {I}_{jm} {\hat{l}}_{k , 2.4} ) ) , ∀ i ∈ {cd ,}_{} j ∈ {2.4}_{} & Eq . 6 \\ {Σ}_{j ∈} {cc}_{ij} = 1 , ∀ i ∈ {cd}_{} & Eq . 7\end{matrix}$$

Where \hat{Q}ᵢⱼ represents the predicted channel availability of the i^{th} AP modified by the load values of its adjacent APs for the selected channel allocation scheme (\vec{cc}ₖ, ∀k∈V_{cd}) and its value is evaluated in the first constraint. The second constraint ensures that each AP is only operating at a single channel.

In one instance, a simulated annealing (SA) based heuristic algorithm may be used (e.g., to solve the optimization), which starts from an initial channel allocation scheme (\vec{cc}^{init}), and at each step changes the channel of one AP and re-evaluate the objective function, Obj(.) given in Eq. 5. Table 4 shows a simulated annealing (SA) based heuristic algorithm for non-backhaul.

TABLE 4
Example of a Simulated Annealing (SA) Based Heuristic Algorithm for Non-Backhaul

1. Start with current channel allocation scheme, \vec{cc}^{old}
2. Select an AP, i randomly, i ∈ V_{cd}
3. Select a channel j, based on channel selection policy
$4. Build a new channel allocation scheme , {\vec{cc}}^{new} , by assigning channel j to AP i ( {\vec{cc}}_{ij}^{new} = 1 , {\vec{cc}}_{im}^{new} = 0 , ∀ m ∈ {2.4}_{} , m \neq j )$
5. If (Obj(\vec{cc}^{new}) ≥ Obj(\vec{cc}^{old}), continue with step 7
6. If (Obj(\vec{cc}^{new}) < Obj(\vec{cc}^{old}), accept the adjustment with acceptance probability and continue
with step 7; if not accepted, jump to step 3 and choose another channel
7. Reduce the system temperature by the cooling rate
8. If all possible search is not done, jump to step 1

Two channel selection policies may be considered: “random channel” where j is randomly selected among all possible channels available other than the current channel following a uniform random distribution; “best channel” where j is selected as the channel with the highest \hat{Z}ᵢⱼ value. Also, the acceptance probability may be calculated as e^{Obj(\vec{cc}}^{^{new}}^{)-Obj(\vec{cc}}^{^{old}}^{)/temp} where temp is the system temperature (e.g., how close one is to finish running the method).

This heuristic may be run rc_{random} times with random channel policy, and rc_{best} times with a best channel policy. Moreover, a depth first search (DFS) heuristic may be run rc_{dfs} times. The output of each heuristic run is may be called a solution that is a triplet

$$s = ( {\vec{cc}}^{s} , {μ}_{s}^{Q} , {σ}_{s}^{Q} )$$

composed of the channel allocation scheme \vec{cc}^{s}, average predicted channel availability

$${μ}_{s}^{Q} ,$$

and standard deviation of predicted channel availability

$${σ}_{s}^{Q} .$$

Notes, [symbol] may refer to the solution pool consisting of solutions of each run. The solution with the highest

$${μ}_{s}^{Q}$$

value as s̅ (e.g., the best solution).

In a backhaul frequency band, a similar method may be performed as for the non-backhaul band.

If each AP is part of a WMN composed of multiple APs where the inter-AP traffic is carried over backhaul frequency band, the channel allocation may be done on a WMN basis.

In such a WMN scenario, the decision variables may be the binary channel allocation variables, ρₒₘ, which has a value of 1 if the o^{th} WMN is operating at channel m, and 0 otherwise. Then, given the raw predicted channel availability values (\hat{Z}ᵢⱼ), the adjacency matrix of M (A(M)), and the predicted channel load values at the 5 GHz frequency band (e.g., backhaul band) (\hat{l}_{k,5}), the optimization problem can be written as

$${maximize}_{{cc}_{ij}} {\sum }_{o ∈ {𝒲}_{cd}} {\sum }_{j ∈ {𝒞}_{5}} {\hat{Q}}_{oj}^{W} {ρ}_{oj} \qquad Eq . 8$$

Subject to:

$${\hat{Q}}_{ij} = max ( 0 , {\hat{Z}}_{ij} - {\sum }_{\begin{matrix}k ∈ {𝒱}_{cd ,} \\ k \neq i\end{matrix}} {\sum }_{m ∈ {C}_{5}} ( {a}_{ik} {cc}_{km} {I}_{jm} {\hat{l}}_{k , 5} ) ) , \qquad Eq . 9$$

$$∀ i ∈ {𝒱}_{cd} , j ∈ {𝒞}_{5}$$

$${\hat{Q}}_{oj}^{W} = min ( {\hat{Q}}_{ij} : ∀ i ∈ {𝒱}_{cd} , 𝔽 ( i , o ) = 1 ) , ∀ o ∈ {𝒲}_{cd} \qquad Eq . 10$$

$${cc}_{ij} = {ρ}_{𝔾 ( i ) , j} , ∀ i ∈ {𝒱}_{cd} , j ∈ {𝒞}_{5} \qquad Eq . 11$$

$${\sum }_{j ∈ {𝒞}_{5}} {ρ}_{oj} = 1 , ∀ o ∈ {𝒲}_{cd} \qquad Eq . 12$$

where

$${\hat{Q}}_{o j}^{W}$$

represents the predicted channel availability of the o^{th} WMN modified by the load values of the APs belong to adjacent WMNs for the selected channel allocation scheme (\vec{ρ}ₖ, ∀k∈ [symbol] _{cd}).

The first constraint evaluates the predicted channel availability of the i^{th} AP modified by the load values of its adjacent APs represented by \hat{Q}ᵢⱼ (Eq. 9). The second constraint sets the WMN-wide channel availability to the worst AP's channel availability within the WMN (Eq. 10). The third constraint sets the new channel of each AP to the new channel of the WMN it belongs to (Eq. 11). Finally, the fourth constraint ensures that each WMN is only operating at a single channel (Eq. 12). Here, [symbol] (i, o) is a function which has a value of 1 if the i^{th} AP belongs to the o^{th} WMN, and 0 otherwise. [symbol] (i) is another function which returns the index of the WMN where the i^{th} AP belongs.

We employ a similar SA based heuristic algorithm for the WMN-wide 5 GHz channel allocation. This heuristic starts from an initial channel allocation scheme (\vec{p}^{init}), and at each step changes the channel of one WMN and re-evaluate the objective function, Obj(.) given in Eq. 8. Table 5 shows a simulated annealing (SA) based heuristic algorithm for backhaul.

TABLE 5
Example of a Simulated Annealing (SA) Based Heuristic Algorithm for Backhaul

1. Start with current channel allocation scheme, \vec{ρ}^{old}
2. Select a WMN, o randomly, o ∈ [symbol]
3. Select a channel j, based on channel selection policy
$4. Build a new channel allocation scheme , {ρ}^{new} , by assigning channel j to WMN o ( {\vec{ρ}}_{ij}^{new} = 1 , {\vec{ρ}}_{im}^{new} = 0 , ∀ m ∈ {5}_{} , m \neq j )$
5. If (Obj(\vec{ρ}^{new}) ≥ Obj(\vec{ρ}^{old}), continue with step 7
6. If (Obj(\vec{ρ}^{new}) < Obj(\vec{ρ}^{old}), accept the adjustment with acceptance probability and continue with
step 7; if not accepted, jump to step 3 and choose another channel
7. Reduce the system temperature by the cooling rate
8. If all possible search is not done, jump to step 1

Here, the two channel selection policies may be applicable, just as described herein, and their results may be combined: random channel and best channel.

In a single AP channel allocation approach, selecting the solution yielding the maximum predicted channel availability value may provide the highest performance improvement. In a channel allocation focusing on groups of APs, using the single AP channel allocation approach may translate to picking the solution yielding the maximum average predicted channel availability, such as the aforementioned s̅. However, s̅ may not be a fair allocation between APs within the group. Moreover, it may allocate less than ideal channels to several APs for the overall greater good of the group. In contrast, a sub-optimal solution, s, yielding a smaller

$${μ}_{s}^{Q} ,$$

but that minimizes

$${σ}_{s}^{Q} ,$$

could be more desirable in terms of fairness and also eliminate some Aps receiving disproportionately worse allocations compared to the whole group. In order to avoid these issues, in some cases, a parameterized solution selection system between selecting the maximizing

$${μ}_{s}^{Q}$$

and minimizing

$${σ}_{s}^{Q}$$

may be used.

First, a second solution pool called potential solutions, [symbol] , may be created as a subset of

[symbol]

$$𝒫𝒮 = \{ ps \vert ps ∈ 𝒮 and ( ( {μ}_{\underline{s}}^{Q} - {μ}_{ps}^{Q} ) \leq {τ}_{adeg} ) \} \qquad Eq . 13$$

where τ_{adeg} is the acceptable degradation threshold depicting the lowest acceptable

$${μ}_{c}^{Q}$$

value from the

$${μ}_{s}^{Q} .$$

Then, a subjective solution quality (SSB) is calculated for each ps as

$${SSB}_{ps} = ( 1 - γ ) \frac{{μ}_{ps}^{Q} - {μ}_{worst}^{Q}}{{μ}_{\overline{s}}^{Q} - {μ}_{worst}^{Q}} + γ \frac{{σ}_{worst}^{Q} - {σ}_{ps}^{Q}}{{σ}_{worst}^{Q} - {σ}_{best}^{Q}} where {μ}_{worst}^{Q} = min \{ {μ}_{i}^{Q} \} , i ∈ 𝒫𝒮 , {σ}_{worst}^{Q} = max \{ {σ}_{i}^{Q} \} , i ∈ 𝒫𝒮 , {σ}_{best}^{Q} = min \{ {σ}_{i}^{Q} \} , i ∈ 𝒫𝒮 \qquad Eq . 14$$

and γ is a weight parameter determining the importance of selecting the solution with the minimum standard deviation. Then, the solution with the highest SSB may be selected as the suggested solution ss. Note, with a γ value of 0, the system may select s̅ whereas with a γ value of 1, the system may select the solution that minimizes

$${σ}_{c}^{Q} .$$

The improvement of ss may be checked against a threshold, τ_{mchsw}, to decide whether the solution should be executed or not. Here, only the APs whose absolute channel availability change over the initial solution exceeding a change threshold, τ_{chg}, may be considered (e.g., |\hat{Q}ᵢⱼ−Yᵢⱼ|≥τ_{chg}). This is done to focus only on the APs where ss introduces a considerable change and is especially important in a large graph where such considerable changes are done only in several APs.

As disclosed herein, one or more equations, examples, techniques, approaches, etc., may be presented from the perspective of a specific frequency band, where 2.4 ghz might server as a front haul and 5 Ghz might serve as a backhaul. However, this is intended as examples, and may be applicable to any configuration for a fronthaul and a backhaul (e.g., using one or more frequency band for fronthaul and/or using one or more frequency band as backhaul). It follows that the disclosed equations may be applied to any band, unless otherwise specified. Each band may be assessed on its own, and not combined for channel assessment.

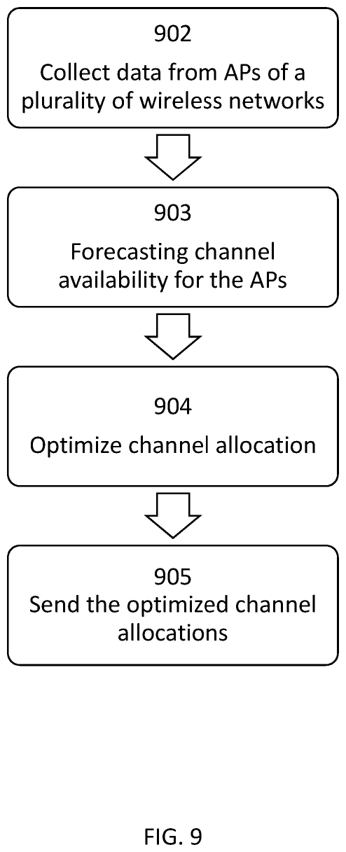

FIG. 9 illustrates an example process. In this example, there may be a dynamic channel allocation method to coordinate channel allocation among a plurality of wireless networks (e.g., each located in a unit of multi-dwelling units). Initially (e.g., 902), the process may begin with collecting channel availability information from each wireless network of a plurality of network. Next (e.g., 903), the process may include forecasting a channel availability for each channel and for each wireless network by considering whether the networks in separate units are neighbors or not. Next (e.g., 904), the process may utilize an optimization algorithm to find the channel allocation that maximizes the total channel availability of APs at their allocated channels. Finally (e.g., 905), the process may include instructing the APs (e.g., of the plurality of wireless networks) to switch to the found optimal channel(s).

One or more step or element of any example, process, method, approach, etc., described herein may be optional, or may be performed in a different order.

What is claimed:

1. A method implemented by a controller, the method comprising:
collecting clear channel assessment (CCA) information from each wireless network of a plurality of wireless networks;
forecasting a channel availability for each channel for each wireless network based on whether one or more of the plurality of wireless networks are neighbors;
using an optimization algorithm to find an optimal channel that maximizes a total channel availability; and
sending instructions to switch to the optimal channel.

2. The method of claim 1, wherein the CCA information includes measurements, where the measurements are performed between 30 and 50 ms.

3. The method of claim 2, wherein the measurements are aggregated to generate representative data, wherein the forecasting is further based on the representative data.

4. The method of claim 1, wherein the forecasting uses an exponential smoothing algorithm or a moving average algorithm.

5. The method of claim 1, where a neighbor may be determined based on at least one AP of one wireless network having a connection with another AP of another wireless network.

6. The method of claim 1, wherein the optimization algorithm may include ranking one or more channels based on the CCA information.

7. A controller, the device comprising:
means for collecting clear channel assessment (CCA) information from each wireless network of a plurality of wireless networks;
means for forecasting a channel availability for each channel for each wireless network based on whether one or more of the plurality of wireless networks are neighbors;
means for using an optimization algorithm to find an optimal channel that maximizes a total channel availability; and
means for sending instructions to switch to the optimal channel.

8. The device of claim 7, wherein the CCA information includes measurements, where the measurements are performed between 30 and 50 ms.

9. The device of claim 8, wherein the measurements are aggregated to generate representative data, wherein the forecasting is further based on the representative data.

10. The device of claim 7, wherein the forecasting uses an exponential smoothing algorithm or a moving average algorithm.

11. The device of claim 7, where a neighbor may be determined based on at least one AP of one wireless network having a connection with another AP of another wireless network.

12. The device of claim 7, wherein the optimization algorithm may include ranking one or more channels based on the CCA information.
